(19) United States
(12) Patent Application Publication
(10) Pub. No.: US 2026/0202345 A1
(43) Pub. Date: Jul. 16, 2026

(54) DEVICE AND METHOD FOR SENSOR-BASED INSPECTION OF AN OBJECT

(71) Applicant: MB Automation GmbH & Co. KG, Roding (DE)

(72) Inventors: Ondrej Vasko, Schwandorf (DE); Christina Breu, Chamerau (DE)

(21) Appl. No.: 18/867,725

(22) PCT Filed: May 24, 2023
(86) PCT No.: PCT/EP2023/063918

§ 371 Date: Nov. 20, 2024

(30) Foreign Application Priority Data
May 25, 2022 (DE) 102022113313.3

(51) Int. Cl. G01N 21/88; G01N 21/84; G01N 21/86; G01N 21/89

(52) U.S. Cl. CPC G01N 21/8851; G01N 21/86; G01N 21/8901; G01N 21/8914; G01N 2021/845; G01N 2021/8918

(57) ABSTRACT

A device for sensor-based inspection of a physical object, especially a planar or ribbon-shaped physical object, includes a transportation apparatus; an image sensor system; an illumination apparatus; and a shielding apparatus. In this case, the image sensor system includes a number N, with N≥1, of digital line cameras, each with a plurality K of camera pixels arranged in a line, with the lines of the line cameras in each case extending across, in particular orthogonal to, the transportation path. The device or a method performable therewith can be used in particular for inspecting electrodes, or preliminary stages thereof, for galvanic elements.

### CROSS-REFERENCE TO RELATED APPLICATION

This application is a national stage entry of, and claims priority to, International Patent Application No. PCT/EP2023/063918, filed May 24, 2023, which claims priority to German Patent Application No. 102022113313.3, filed May 25, 2022, with the same title as listed above. The above-mentioned patent applications are incorporated herein by reference in their entireties.

### TECHNICAL FIELD

The present invention relates to a device and a method for sensor-based inspection of physical objects, wherein in particular (at least macroscopically) substantially flat surfaces of the objects can be inspected, such as surfaces of planar or ribbon-shaped objects. The invention also relates to the specific use of the device and/or the method for inspecting an electron substrate of an electrode for a galvanic element or a coating of such an electron substrate with an anode or cathode material.

### BACKGROUND

When manufacturing or using a wide variety of physical objects, i.e. objects that take up space and mass, in particular intermediate or final products of industrial production processes, it is important to ensure that the objects are of high quality. The quality requirements may in particular concern the integrity or purity of one or more surfaces of the object. An example of such objects are electrodes for galvanic elements, such as lithium-ion batteries, which are used in a variety of electronic devices and in particular also in the context of electromobility to supply energy to vehicles, such as cars, or to temporarily store electrical energy in stationary systems. It is particularly important that the electrodes are largely free of contamination, because in addition to reducing the performance of the galvanic element, such contamination, especially particulate contamination, could potentially lead to electrical short circuits and thus to failure of the galvanic element and even to dangerous situations.

In known solutions, as part of the quality assurance process, batteries that have already been manufactured at the factory and may contain one or more galvanic elements are tested to determine whether or not electrical short circuits occur. This test is carried out stationary, i.e. when the battery to be tested is at rest relative to the test device by which the test is carried out.

The present invention is based on the object of providing an improved solution for the quality control of physical objects, in particular electrodes for galvanic elements or precursors thereof.

### SUMMARY

This object is achieved according to the devices and methods described below.

A first aspect of the solution presented here relates to a device for sensor-based inspection of a physical object, in particular a planar or ribbon-shaped object. The device comprises:
(i) a transportation apparatus, in particular with one or more conveyor belts, for transporting a physical object to be inspected along a transportation path;
(ii) an image sensor system having at least one image sensor for image sensor-based acquire of the object at least in portions while the object is moved continuously by the transportation apparatus along the transportation path, namely without stopping but not necessarily at a constant speed, relative to the image sensor system;
(iii) an illumination apparatus for illuminating a respective surface of the object to be inspected, in particular a macroscopically flat surface, in a wavelength range that can be acquired by the image sensor system, in particular in the visible range (VIS) of the electromagnetic spectrum, so that the image sensor system can perform an image sensor-based acquire at least of portions of the surface within such a illuminated surface region; and
(iv) a shielding apparatus for shielding the image sensor system from radiation that does not originate from the illumination apparatus, in particular in the wavelength range;

The image sensor system comprises a number N, with N≥1, of digital line cameras, each with a plurality of camera pixels arranged in a line, wherein the lines of the line cameras each extending across, in particular orthogonal to, the transportation path.

The term “physical object” as used herein means something that has space and mass. In particular, a massive industrial product is a physical object. This includes in particular an electrode for a galvanic element, in particular a lithium-ion cell or battery, or a precursor of such an electrode, a catalyst-coated membrane, a gas diffusion layer or a membrane electrode assembly (MEA) as a precursor of a fuel cell.

The term “line camera” as used herein means an image sensor or a camera of a digital camera type having a digital image resolution of M x K camera pixels, where (i) M≥1000·K and K≤256, and/or (ii) M>K with K=1. M denotes the number of camera pixels per line and K the number of lines. In particular, a line camera can therefore also only have a single (K=1) radiation-sensitive line (line sensor)—in contrast to the two-dimensional sensor, which has a large number of lines. The camera pixels can each have several subpixels for different colors, e.g. according to the RGB color model or another color model.

As possibly used herein, the terms “comprises,” “contains,” “includes,” “includes,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”.

The terms “another” and “a further” and any other variant thereof are to be understood to mean “at least one other”.

The term “plurality” as possibly used herein is to be understood to mean “two or more”.

The term “configured” or “set up” to perform a specific function (and respective modifications thereof), possibly used herein, is to be understood to mean that the corresponding device or component thereof is already provided in a design or setting in which it can execute the function or that it is at least adjustable-namely configurable-so that it can execute the function after corresponding adjustment. The configuration can take place, for example, via a corresponding setting of parameters of a process or of switches or the like for activating or deactivating functionalities or settings. In particular, the device can comprise multiple predetermined configurations or operating modes, so that the configuration can be carried out by selecting one of these configurations or operating modes.

A device according to the solution enables a sensor-based inspection of a physical object while it is continuously transported by the transportation apparatus. The object does not have to be stopped at a special station and then set in motion again, and because such stops are eliminated during the inspection process, short throughput times and thus process efficiency can be achieved. Furthermore, if the object is a device, such as a galvanic cell or an entire battery with several such cells, the entire device does not have to be completed for the purpose of inspecting components of such a device, in particular electrodes. Rather, it is possible that intermediate products are already being inspected. If they are identified as faulty, they can be sorted out without the device having to be completed. This means that the total amount of material required for the series production of such devices can be reduced, since when a fault is acquired, only the component identified as defective and not an already completed device needs to be rejected or repaired. Overall, the solution helps to ensure that errors in production can be acquired early and in a particularly efficient manner, thus counteracting quality defects.

However, not only advantages in terms of efficiency can be achieved, but in particular the combined use of the special image sensor technology with N line cameras, the lighting device and the shielding apparatus also make it possible to achieve a high image quality and resolution, so that even very small disturbances, for example the smallest particles present on the surface to be inspected, can be acquired particularly well. This is particularly due to the fact that line cameras can generally achieve a particularly high effective resolution, the lighting device provides good lighting conditions and in particular also the possibility of clearly recognizable shadows cast by disturbances to be acquired (in particular particles present on a surface), and the shielding apparatus ensures that the images provided by the image sensor system are particularly low-noise, since disruptive influences from radiation not originating from the lighting device are at least largely removed.

These advantages are particularly evident when the device according to the solution is used in the manufacture of electrodes for galvanic elements, where it is important to avoid even small disturbances, in particular particles on the electrodes, or, if necessary, to detect them in good time during an inspection of the electrodes or of preliminary products thereof before the galvanic cell is completed using the electrodes. In addition, the problem that regularly arises during the manufacture of such electrodes is that processes are used in which there is a possibility or danger that small particles, in particular small carbon particles, will be released. This can be the case in particular when punching the electrodes from a larger substrate, when applying layered cathode or anode material (e.g., carbon powder) to an electrode base substrate (e.g., a copper foil), or when subsequently calendering such applied layers. In particular, the situation may arise that very small particles, in particular black carbon particles on an object surface of essentially the same color (e.g. calendered carbon layer) are to be acquired during the inspection.

Preferred exemplary embodiments of the device are described hereinafter, which in each case, unless expressly excluded or technically impossible, can be combined as desired with one another and with other aspects of the present solution, which will be described in the following.

In some embodiments, the transportation apparatus is configured to move the object relative to the image sensor system in such a way that-in particular in the case of a planar, cuboid-shaped or ribbon-shaped object-at least two opposite sides of the object can be simultaneously or sequentially in a sensor-based manner by the image sensor system. The image sensor system can comprise one or more line cameras separately for each of the two sides to be acquired. This means that both sides can be inspected using the same device.

In some embodiments, the transportation apparatus comprises: (i) a first conveyor apparatus (which may in particular comprise a vacuum conveyor belt) which is configured to transport the object lying down, while a first side of the object is at least partially acquired by the image sensor system; and (ii) a second conveyor apparatus (which may in particular comprise a vacuum conveyor belt) which is configured to transport the object hanging, while a second side of the object opposite the first side is at least partially acquired by the image sensor system. For example, the transportation apparatus can be configured to initially transport the object lying down on the first conveyor apparatus and inspect the first side, then to transfer the object to the second conveyor apparatus in a transfer area, for example by suction on an underside of the second conveyor apparatus, and then to inspect the now freely accessible second side from below. This means that there is no need to turn the object and yet a very efficient, time-saving, inspection process can be achieved for both sides.

In some other embodiments, the transportation apparatus comprises a turning device for turning the object, which is configured to turn the object between an at least partial image sensor-based acquisition of a first side of the object and an at least partial image sensor-based acquisition of a second side of the object opposite the first side. In particular, this makes it possible to use an image sensor that is only located on one side of the transportation apparatus, despite inspection from both sides. This makes it possible to implement particularly compact device designs, especially with a low overall height.

In some other embodiments, the transportation apparatus has two conveyor apparatuses separated from each other by a gap (which in particular can each have a vacuum conveyor belt), which are each configured to transport the object lying or suspended. The image sensor system is configured in this case to perform image sensor-based acquisition of the two opposite sides of the object, while a section of the object to be acquired on both sides using image sensors passes through the gap during operation of the transportation apparatus. The two sides can thus be inspected simultaneously or in partially overlapping inspection periods, which is particularly advantageous with regard to high process efficiency and high achievable throughput.

In some embodiments, the device further comprises a separating apparatus arranged upstream of the image sensor system in relation to the transportation path for separating the object from a starting object, in particular a starting substrate, such as a sheet, a plate or a ribbon. In this way, the inspection can be carried out on the basis of objects that have already been isolated, which is particularly advantageous if the object is turned during the process or as preparation for the individual rejection of objects identified as defective during the inspection. In particular, in these embodiments comprising separation, the transportation apparatus can also be configured in such a way that it pauses the transport before subsequently feeding the next separated object to the image sensor system for inspection.

In some embodiments, the transportation apparatus has a transportation table which is connected upstream of the separating apparatus with respect to the transportation path and has at least two asynchronously operating fixing apparatuses, each movable along the direction of the transportation path, for temporarily fixing the object on the transportation table. The device is configured to control the movements of the fixing apparatuses in a coordinated manner such that they interact for step-wise feeding the starting object to the separating apparatus in order to enable the object to be separated from the starting object in each step while the starting object is at rest relative to the transportation apparatus.

In some embodiments, the device further comprises a cleaning apparatus for cleaning the object, which is arranged upstream of at least one of the line cameras of the image sensor system with respect to the transportation path, in particular arranged between the separating apparatus and the image sensor system with respect to the transportation path. In this way, not only can undesirable disturbances on the object surface to be inspected be acquired, but the occurrence of such disturbances can be reduced, especially in the case of disturbances caused by particles loosely located on the surface.

In some embodiments, the image sensor system is configured such that at least one of its line cameras has an optical axis the direction of which defines a fixed or variably, in particular temporally variable, adjustable acute angle φ with φ<90° with respect to a support surface provided on the transportation apparatus for acquiring the object during image sensor acquisition. Due to the acute angle φ, it is in particular possible to largely avoid the acquisition of scattered light reflected from the object during orthogonal irradiation, in particular from radiation sources other than the illumination apparatus, which potentially has a detrimental effect on image quality. In general, this can be expressed as follows: the optical axis(es) of the line camera(s) are or will be aligned in such a way that they are not coaxial with an illumination direction defined by the illumination direction and/or a main direction of incidence of radiation from another illumination source. Furthermore, due to the acute angle φ, any shadows cast by the object can be more easily acquired and used for subsequent image analysis in order to more easily identify disturbances on the inspected object surface indicated by the shadow. In the case of variable setting of the angle φ, the field of view of the at least one line camera can also be varied, in particular dynamically, in particular depending on a transport speed with which the transportation apparatus transports the object to be inspected. In this way, a surface section of the object can be acquired by image sensors from different observation directions during its inspection, which makes it possible in particular to acquire and evaluate any variations in the acquired image material that may occur depending on the varying angle φ, in particular with regard to disturbances that can only be identified on the basis of these variations.

In some embodiments, the image sensor system comprises at least one mirror and is configured such that at least one of the line cameras has an optical axis directed toward the mirror, such that the line camera can perform image-sensor-based acquisition of a mirror image of at least a portion of the object generated by the mirror. This enables particularly compact, particularly flat designs, since the extension of the image sensor in a direction orthogonal to the transport direction can be thus kept particularly small.

In some embodiments, the image sensor system has, in addition to the N line cameras, at least one further camera the field of view of which extends along a direction running transversely, in particular orthogonally, to the transport direction beyond the cumulative field of view of the N line cameras. This makes it possible to inspect areas, especially projections, of an object that extend beyond the cumulative field of view of the N line cameras. Especially in the case of electrodes, especially lithium-ion cells, such electrodes often each have a so-called discharge tab for discharging current from the electrode, which extends laterally as a projection beyond the electrochemically active surface of the electrode. If such electrodes are transported by the transportation apparatus in such a way that the conductor tabs extend away from the active surface of the electrode in a direction transverse to the transport direction, in particular orthogonal to the transport direction, then the conductor tabs can be inspected by the further camera even if they extend completely or partially beyond the cumulative field of view of the N line cameras. In particular, it is possible to inspect any transitions between an electrode coating and the discharge tab. In many cases, the discharge tab is completely uncoated (namely not coated with the active material of the electrode) and there is a coating edge at the transition between the discharge tab and the electrode. In particular, not only particles can be acquired as disturbances, but also coating defects and flaking of the coating.

In some embodiments, the image resolution of at least one of the line cameras is at least 6.8 μm per pixel, preferably at least 2.0 μm per pixel. In this way, even very small disturbances, especially particles, with dimensions of comparable size (e.g. a disturbance is mapped to at least one pixel) can still be acquired and detected using image sensors. The variables mentioned have proven to be particularly useful, at least with regard to the acquisition of carbon particles and other particles during an electrode inspection during or after their manufacture, in order to be able to easily acquire any faults that may endanger the quality and/or safety of the electrodes.

In some embodiments, the image sensor system comprises an optic in its optical path with a magnification factor in the range of −0.675× to −0.875×, in particular a lens optic with at least one optical lens. These magnification values have proven to be particularly useful for achieving large fields of view (FoV) despite the compact design of the device. In particular, the optics can have at least one spacer ring for determining the magnification factor. This means that the magnification factor can be kept particularly stable due to the distances between the image sensors (especially line cameras) and the optics, which are (co-)determined by the spacer ring(s). The distance between the optics and the object is also clearly defined, at least in terms of a minimum distance. The desired field of view and the desired resolution can thus be achieved by using special spacer rings, in particular to set a defined ratio between the distances from the optics to the object and from the optics to the image sensor. The diameter of the distance rings should preferably be chosen to be sufficiently large so that the intensity of the radiation (in particular light) to be acquired incident on the sensor can be kept at least approximately homogeneous.

In some embodiments, the shielding apparatus comprises one or more darkrooms in which the N line cameras are housed together to protect them from radiation not originating from the illumination apparatus. This is a particularly effective way to prevent possible impairments of the image quality provided by the image sensor and thus of the quality of the inspection based on it.

In some embodiments, the device is configured to control or regulate a recording frame rate of the image sensor depending on the transport speed of the object during its continuous transport through the transportation apparatus. Depending on the defined dependency (which can in particular be defined via a mathematical function), it is possible to achieve (i) a variable setting of the extension of the field of view of the image sensor along the transport direction depending on the transport speed, or (ii) to keep this extension invariant with respect to different transport speeds. For this purpose, in particular a measuring device (e.g. encoder) can be provided, which can be connected to the drive of the transportation apparatus and the image sensor system.

In some embodiments, the illumination apparatus comprises one or more light-emitting diodes as radiation sources for illuminating the surface of the object to be inspected. In particular, very compact designs with low energy consumption and/or, at least essentially, monochromatic illumination (and thus particularly high image sharpness) can be realized.

In some embodiments, the illumination apparatus has a main radiation direction and is configured to illuminate the surface of the object to be inspected such that the main radiation direction runs at a fixed or time-varying acute angle α with α<90° to a support surface present on the transportation apparatus for receiving the object during image sensor acquisition. Due to the acute angle a, any shadows cast by the object can be created and used for subsequent image evaluation in order to more easily identify disturbances on the inspected object surface indicated by the shadow.

In some embodiments, the illumination apparatus is configured to provide diffuse illumination of the respective surface of the object to be inspected. This makes it particularly easy to make visible disturbances that would not be visible or would be difficult to acquire with directed illumination from only one direction. In particular, when using diffuse lighting, shadows cast by particles or many other types of disturbances in different directions can be created and differences with direction-dependent reflection of the incident radiation on the object can also be acquired. Overall, this increases the probability of acquiring faults, especially very small faults.

In some embodiments, the transportation apparatus is designed to be configurable such that its position can be adjusted along a direction running transversely, in particular orthogonally, to the transportation path. This makes it possible to adjust the transportation path relative to the image sensor, which can be used in particular to optimally bring the object to be inspected into the field of view of the image sensor.

In some embodiments, the device further comprises an image evaluation apparatus for evaluating image material acquired by the image sensor system in order to detect any deviations of the object depicted in the image material from a reference state, in particular from a predefined target state, of the object by image processing.

A second aspect of the present solution relates to a method for sensor-based inspection of a physical object, in particular a planar or ribbon-shaped object, wherein the method is carried out using a device according to the embodiments described herein. The object can in particular be an electrode for a galvanic element, in particular for a lithium-ion cell or battery, or a precursor of such an electrode, such as an electrode substrate (e.g. copper foil) not yet coated with anode or cathode material or an electrode substrate already coated in this way before or after calendering (rolling of the anode or cathode material) and/or separating.

A third aspect of the present solution relates to the use of a device according to the first aspect or the method according to the second aspect, in each case for inspecting an electrode substrate, in particular a planar or ribbon-shaped one, of an electrode for a galvanic element or a coating of such an electrode substrate with an anode or cathode material. Such use can be carried out in particular in the context of a process for producing such an electrode, in particular in order to be able to acquire defects on the electrode surface at an early stage, such as undesirable particle deposits, and to be able to remove such defective products or precursor products from the process as scrap or for reprocessing before they are completed.

The features and advantages explained with respect to the first aspect of the invention also apply correspondingly to the further aspects of the invention.

### BRIEF DESCRIPTION OF THE DRAWINGS

Further advantages, features, and possible applications of the present invention result from the following description in more detail in conjunction with the figures. In the figures:

FIG. 1 shows a first embodiment of a device for sensor-based inspection of one or more physical objects, in particular electrodes.

FIG. 2 shows a second embodiment of the device.

FIG. 3 shows a third embodiment of the device.

FIG. 4 shows a fourth embodiment of the device.

FIG. 5 shows a first variant for the arrangement of the image sensor system.

FIG. 6 shows a second variant for the arrangement of the image sensor system.

FIG. 7 shows a third variant for the arrangement of the image sensor system.

FIG. 8 shows a fourth variant for the arrangement of the image sensor system.

FIG. 9 shows a side view of an arrangement of multiple line cameras of the image sensor system.

FIG. 10 shows a plan view of several electrodes to be inspected lying on the transportation apparatus and the position of the fields of view of the cameras of the image sensor system relative to them.

FIG. 11 shows a flow chart illustrating an embodiment of a method for inspecting objects using the device, in particular the device from FIG. 1.

In the figures, the same reference numerals denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Functional units can be implemented in particular as hardware, software or a combination of hardware and software.

### DETAILED DESCRIPTION

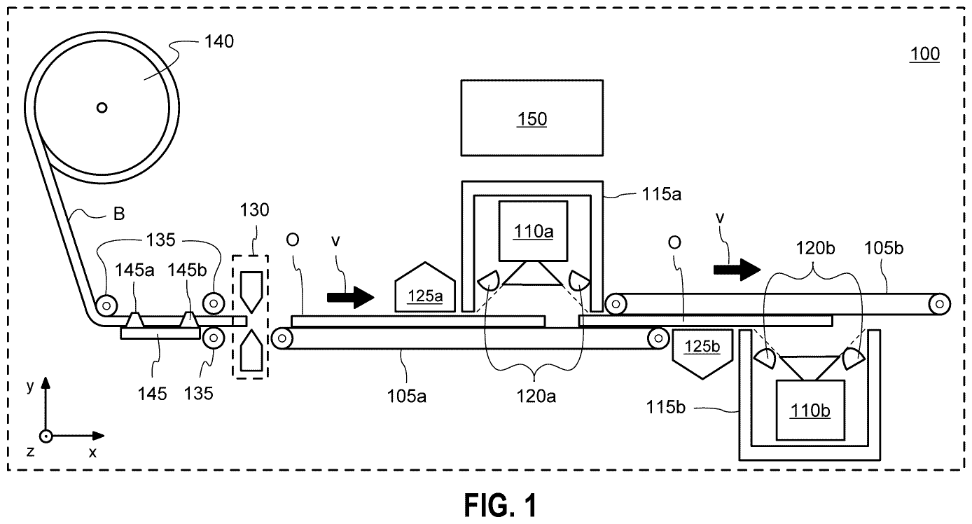

In FIG. 1, a first embodiment 100 of a device for sensor-based inspection of one or more physical objects O is illustrated. In principle, this makes it possible to inspect a wide variety of objects with essentially flat surfaces that lie opposite one another. The objects O can accordingly be in particular band-shaped, foil-shaped, sheet-shaped or planar. In the following, without this being understood as a limitation, examples of objects O will be discussed which are foil- or planar electrodes E for galvanic elements, in particular for lithium-ion cells.

The device 100 has a transportation apparatus including a first vacuum transport belt 105a and a second vacuum transport belt 105b, each configured to transport the objects O along a transportation path along a transport direction x at a speed v that can be constant or variable over time. The two vacuum conveyor belts 105a and 105b are arranged relative to each other in such a way that an object O can initially be transported lying down on the first vacuum conveyor belt 105a and then transported further hanging by the second vacuum conveyor belt 105B (or vice versa, not shown). For this purpose, the two vacuum conveyor belts overlap in a transfer area and are spaced apart from each other there in such a way that the objects O can be moved into the resulting gap in the transfer area and can be sucked up by the second vacuum conveyor belt in order to be able to transport the other one hanging on it.

Accordingly, in the region of the first vacuum conveyor belt 105a, a first (upper) main surface of the respective object O is accessible, while it rests on the first vacuum conveyor belt 105a with its second main surface opposite the first main surface. In the area of the second vacuum conveyor belt 105b, the object rests with its first main surface hanging on the second vacuum conveyor belt 105b, while its second (lower) main surface is accessible.

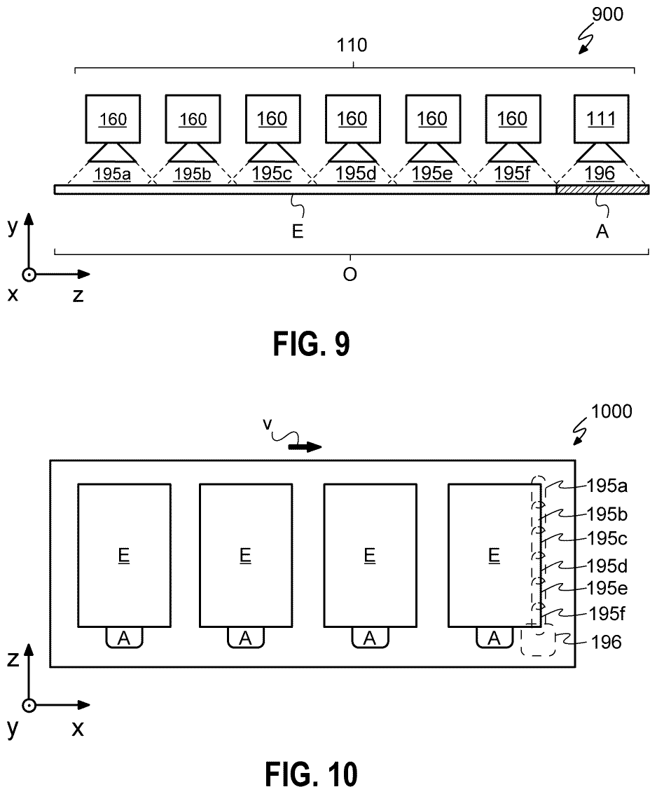

In order to enable image sensor acquisition of the two main surfaces, the device 100 has an image sensor system which has two separate image acquisition units 110a and 110b, each of which has N digital line cameras 160, with N≥1, in particular a group of several line cameras 160 arranged coaxially (along the Z direction) and thus transversely, in particular orthogonally, to the transport direction x and adjacent to one another (cf. FIGS. 9 and 10). In the following, it is assumed, by way of example, that each image acquisition unit 110a or 110b has several line cameras 160, namely that N>1 then applies.

These line cameras 160 are configured in such a way that they can scan the object O transported along the image acquisition units 110a and 110b during its transport using image sensors in order to generate corresponding image material (image data) which represent the respective scanned surface at least in sections and can serve as a basis for subsequent image evaluation by an image evaluation apparatus 150 for detecting disturbances, in particular any particles that may be present, on or in the respective surface. The image evaluation apparatus 150 can in particular also be configured as a control device of the device 100, in particular for controlling its individual functional components and their interaction.

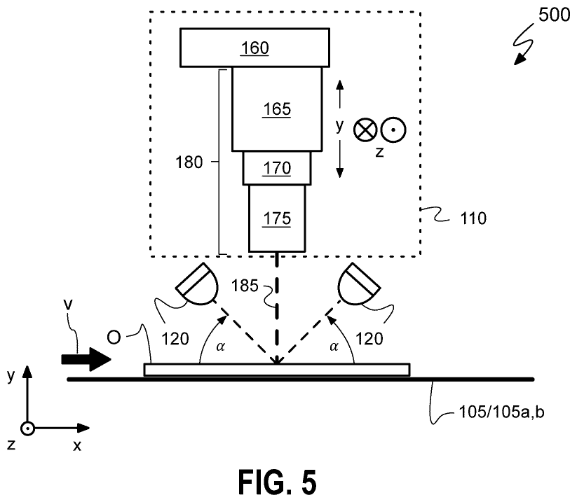

Each of the image acquisition units 110a and 110b is equipped with a respective shielding apparatus 115a or 115b in the form of a darkroom, which is configured such that it provides extensive shading of the field of view of the line cameras 160 against radiation originating from outside the respective shielding apparatus 115a or 115b, in particular scattered light. For the purpose of illuminating the surfaces of the objects O to be scanned by the line cameras 160, an illumination apparatus 120a or 120b is provided in each of the darkrooms, which can in particular have one or more light-emitting diodes as radiation sources. Further details of the illumination apparatus of the image acquisition units 110a and 11b will be referred to below with reference to FIGS. 5 to 10.

Each of the two image acquisition units 110a and 110b is preceded by a respective cleaning apparatus 125a or 125b (relative to the transport direction x). Each cleaning apparatus 125a or 125b is configured to clean, in particular to vacuum without contact, the surface of the objects O to be scanned by the subsequent image acquisition unit 110a or 110b. In particular, deposited particles can be removed, thereby increasing the yield of defect-free objects according to the subsequently generated inspection result.

Now that the inspection section of the device 100 has been explained, a preparation section of the device 100 which precedes the inspection section and serves to feed and separate the objects O to be inspected will be discussed below. In the preparation section, the device 100 has a supply roll 140 for providing a ribbon- or foil-shaped starting substrate B, in particular an electrode substrate (such as a metal foil, which may already be coated with an anode or cathode material). Furthermore, the device 100 has a separating apparatus 130 in the preparation section, which can be designed in particular as a punch, for eample as a roller punch, which serves to separate, in particular cut or punch out, individual objects O, in particular electrodes E (optionally with their discharge tabs A), from the starting substrate B.

It is particularly possible that the separating apparatus 130 comprises a lower tool and an upper tool. The upper tool may include an eccentric drive shaft for cyclically moving a cutting knife or a punch toward the starting substrate B. It is also possible for the separating apparatus 130 to have a clamping device which makes it possible to clamp individual objects O to be cut or punched out of the starting substrate B before and/or during the cutting or punching process. This makes it possible to cut or punch out the objects O with particular positioning precision. The clamping device can be mechanically connected to the upper tool.

The starting substrate B is fed from the supply roll 140 to the separating apparatus 130 in particular by several guide rollers 135, of which one or more, in particular a pair of rollers, can be driven. Furthermore, a transportation table 145 with two associated fixing apparatuses 145a and 145b can be arranged in the preparation section, which are each mounted on the transportation table 145 so as to be translatable at least along the transport direction x. The transportation table 145 with its fixing apparatuses 145a and 145b is configured to feed the starting substrate B step by step to the separating apparatus 130.

In particular, this configuration can be designed such that during operation of the transportation table 145, the fixing apparatus 145a first grips the starting substrate B and pulls or pushes it in the direction of the separating apparatus 130, while the fixing apparatus 145b is released, i.e. the starting substrate B is not fixed. The feed is designed such that the starting substrate B is brought into a designated cutting or punching position relative to the separating apparatus 130, so that when in a next step the fixing apparatus 145b now fixes the starting substrate B while the fixing apparatus 145a returns to its starting position, the starting substrate B can be separated into individual objects O or electrodes by the separating apparatus 130 while it is held in position by the fixing apparatus 145b. The continuous transport through the transportation apparatus therefore only affects the objects O that have already been separated. The starting substrate B, on the other hand, is transported step by step as described, with pauses between the steps during which the separation takes place. Alternatively, the starting substrate B can be fixed to a support of the transportation table 145 using negative pressure. In some embodiments, a storage section, ie a belt buffer (not shown), can be connected upstream of the transportation table 145 (relative to the transport direction x) in order to at least temporarily store the starting substrate B. This allows a continuous feed of the starting substrate B upstream of the transportation table 145. x

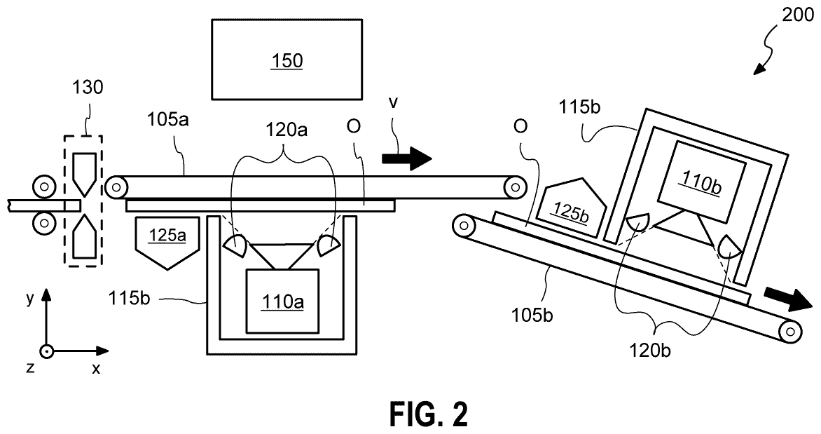

FIG. 2 shows a second embodiment 200 of the device, which is a modification of the embodiment 100. It results from the fact that the second vacuum conveyor belt 105b is pivoted above the z-direction relative to the first vacuum conveyor belt 105a by a fixed angle. Accordingly, the units assigned to the second vacuum conveyor belt 105b, in particular the cleaning apparatus 120b, the shielding apparatus or darkroom 115b, as well as the image acquisition unit 110b located therein with the illumination apparatus 120b, are pivoted accordingly. In this way, a particularly compact design of the device can be achieved. In particular, the device 200 may have a preparation section (only partially shown in FIG. 2) which corresponds to that of the device 100.

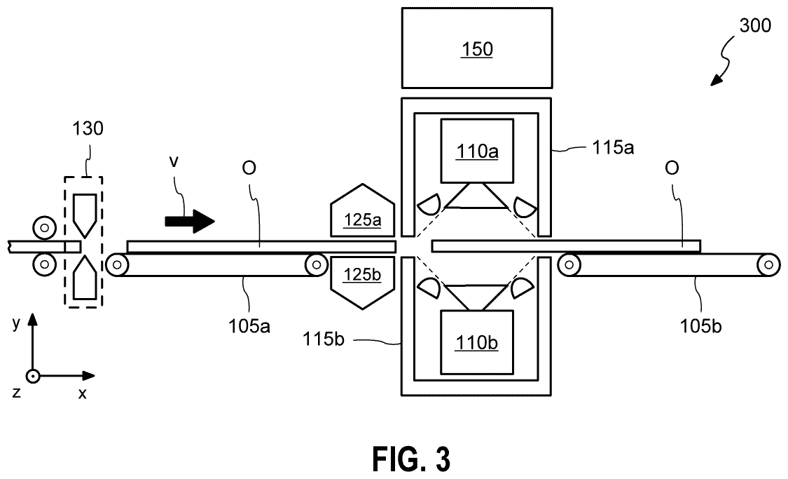

FIG. 3 shows a third embodiment 300 of the device, which is a modification of the embodiment 100. In contrast to this, here the two vacuum conveyor belts 105a and 105b are arranged such that there is a gap between them along the transport direction x, through which the objects O can be subject to image sensor-based acquisition on both sides by the image acquisition units 110a and 110b, which here face each other. Another difference is that the objects O each have the same side
resting on the two vacuum conveyor belts 105a and 105b, in particular—as illustrated—lying down. A variant of this design with hanging or suspended transport of the objects instead is also conceivable.

In particular, the device 300 may have a preparation section (only partially shown in FIG. 3) which corresponds to that of the device 100. The design of 300 enables in particular simultaneous image sensor acquisition of both sides of the objects O and, due to the opposing arrangement of the two image acquisition units 110a and 110b, also a particularly compact design.

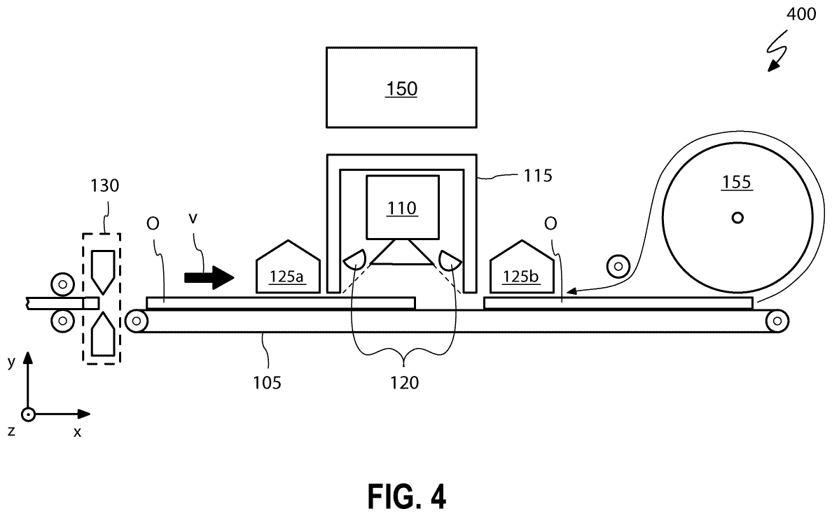

FIG. 4 shows a fourth embodiment 400 of the device, which is a modification of the embodiment 100. In contrast to this, only a single vacuum conveyor belt 105 and a single image acquire unit 110 with associated shielding apparatus 115 and lighting device 120 are provided here. In order to also enable two-sided image sensor acquisition of the objects here, the device 400 has a turning device 155 which is configured such that it turns an object O lying with a first side on the vacuum conveyor belt 105 such that it comes to lie on the same vacuum conveyor belt 105 with a second side opposite the first side. In this way, it is possible to perform image sensor-based acquisition of the first side before turning and the second side after turning of the same image acquire unit 110. A wide variety of configurations are conceivable for the design of the turning device 155, in particular in addition to that shown in FIG. 4 also those where the objects are fed to the image acquisition unit 110 again from the front after turning, namely from the end of the vacuum conveyor belt 105 facing the separating apparatus 130.

In particular, the device 400 may have a preparation section (only partially shown in FIG. 4) which corresponds to that of the device 100. The design of 400 enables in particular a simultaneous image sensor acquisition of both sides of the objects O by a single image acquisition unit 110 and thus in turn also a particularly compact design.

FIG. 5 shows a first variant 500 for the arrangement of the image sensors or of their assembly assigned to a respective image acquisition unit 110 (or 110 a, b). The shielding apparatus 115 is not shown here. The image acquisition unit 110 has at least one line camera 160, in particular—as already described above—a group of several coaxially arranged line cameras 160. Each line camera 160 is combined with an optics 180 having at least a first lens 170 which is spaced from the line camera 160 by a first spacer ring 165. This distance is particularly important for determining a magnification factor of the optics 180 (with). In particular, the magnification factor can be in the range of −0.675× to −0.875×. Furthermore, the optics 180 can have a second spacer ring 175, in which in particular a second lens (or several lenses) can be provided. Overall, the optics 180 thus defines an optical image of a surface section of the object O currently located in the field of view along an optical axis 185 of the image acquisition unit 110 onto the line camera 160 assigned to the optics 180.

The lighting device 120 here has at least one light source, in particular—as shown—two light sources, which illuminate the surface section of the object to be acquired by the image sensor from above from different sides at a respective angle α, which can in particular be an acute angle (α<90°). If there are several light sources, these respective angles α can differ with respect to the light sources or, as illustrated, be the same in order to achieve the most homogeneous illumination possible. The use of such oblique irradiation is particularly advantageous with regard to avoiding reflections of the radiation of the illumination apparatus 120 on the surface of the object O along the optical axis 185. Due to the acute angle α, any shadows cast by the object can be created and used for subsequent image evaluation in order to more easily identify disturbances on the inspected object surface indicated by the shadow.

The image acquisition unit 110 is translatable along the y-direction and/or the z-direction. In this way, on the one hand, the size of the field of view and, on the other hand, its relative position to the vacuum conveyor belt 105 or the objects O transported thereby can be adjusted along the z-direction running orthogonal to the transport direction x. Adjustability along the x-direction is also conceivable, which can be used in particular to adapt the position of the image acquisition unit 110 to different product sizes. The image acquisition unit 110a or 110b or the shielding apparatus 115a or 115b can in particular be arranged on a rail that can be translated along the z-direction and can be moved out of the shielding apparatus 115, e.g. for maintenance purposes.

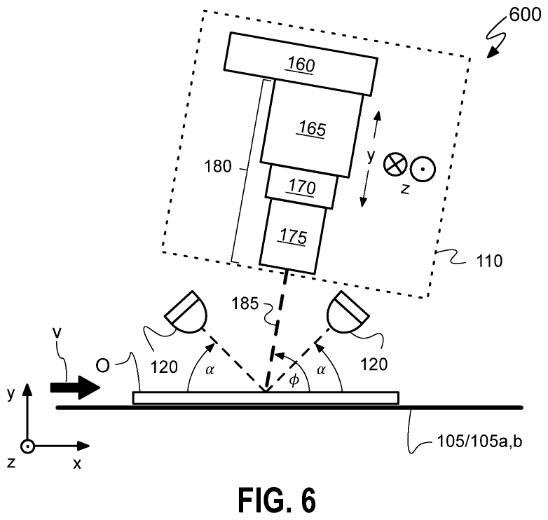

FIG. 6 shows a second variant 600 for the arrangement of the image sensors or of their assembly assigned to a respective image acquisition unit 110 (or 110 a, b). The variant 600 is a modification of the first variant 500, in which the image acquisition unit 110 is tilted relative to a perpendicular to the transport direction x or to the surface of the vacuum conveyor belt 105 (or 105a, b) and thus encloses an (acute) angle φ with φ<90°.

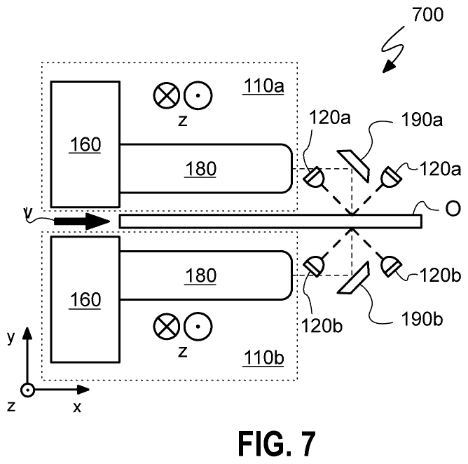

FIG. 7 shows a third variant 700 for the arrangement of the image sensors, which is particularly applicable within the framework of the third embodiment from FIG. 3. A special feature of this third variant 700 is that the two image acquisition units 110a and 110b are each arranged such that their respective optical axes run parallel to the transport direction x and are directed towards a respective mirror 190a or 190b, which deflects a surface section of a respective side of the object O that is currently to be scanned in the direction of the respective optical axis, in order to enable image sensor acquire by the respective line cameras 160. This makes particularly flat designs (in the y-direction) possible.

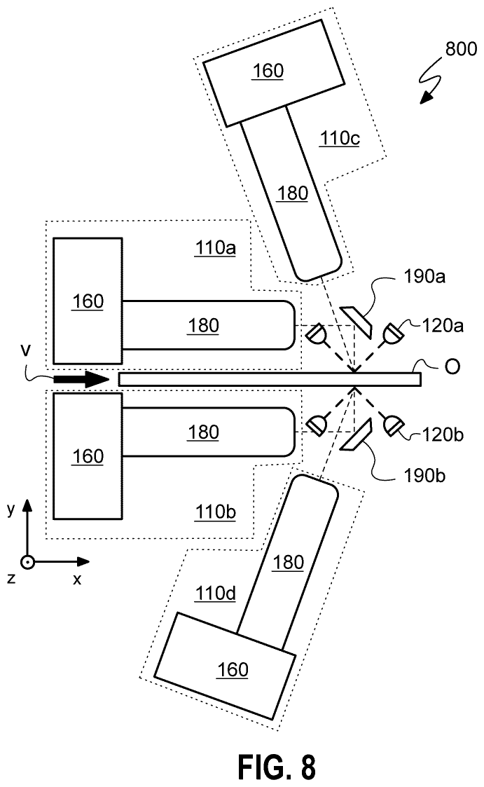

FIG. 8 shows a fourth variant 800 for the arrangement of the image sensors, which has emerged as a modification of the variant 700 and how this is particularly applicable within the framework of the third embodiment from FIG. 3. Compared to the variant 700, the variant 800 has also at least one further image acquisition unit 110c or 110d on each side (top and bottom in FIG. 8), which are each arranged such that their respective optical axes run parallel to the transport direction x and are directed towards a respective mirror 190a or 190b, which deflects a respective surface portion of a respective side of the object O to be scanned momentarily in the direction of the respective optical axis, in order to enable image sensor-based acquisition by the respective line cameras 160. This makes particularly flat designs (in the y-direction) possible.

FIG. 9 shows a detailed view 900 of an image acquisition unit 110 in a side view in the viewing direction antiparallel to the transport direction (x-direction). The image acquisition unit 110 has a plurality of line cameras 160, which in turn each have at least one line of K, with K>1, camera pixels, which together, in interaction with the optics 180 (not shown here), (co-)define a field of view 195a to 195f of the respective line camera 160. The value for K can differ for the different line cameras 160. The line cameras 160 are arranged coaxially along the z-direction such that their respective fields of view 195a to 195f each overlap with the adjacent fields of view, resulting in an overall uninterrupted scanning area aligned along the z-direction. In addition, a further camera 111 with its own field of view 196 can be provided, which can also be a line camera or a 2D or 3D camera. In the present example, it is intended in particular to extend the cumulative field of view of the image acquisition unit 110 laterally along the z-direction in order to be able to acquire lateral projections of the objects O that extend beyond the cumulative field of view of the line cameras 160. x

This is illustrated by way of example in FIG. 10, which shows an application example 1000 in a top view of objects lying on a vacuum conveyor belt 105, in which electrodes E for galvanic elements serve as objects O to be inspected, wherein each of the electrodes E has a lateral projection A which serves to derive an electrical current from the electrode during its later use in a galvanic element and is usually referred to as a discharge tab. The additional camera 111 was used to specifically inspect the discharge tab, while the line cameras 160 were used to inspect the main surfaces of the electrodes E that were chemically active during later operation. In particular, the size of the discharge tab and, for example, the coating transition between the active main surface and the discharge tab can also be checked.

In one embodiment, the one-or two-sided inspection of the discharge tab using the camera 111 can be carried out upstream of the separating apparatus 130, i.e., it can be carried out before or after the inspection using the image sensor system 110. For example, the surface quality of the discharge tab can be determined using dark field illumination (illumination approx. 45 degrees). It is then also possible to generate one or more different lighting patterns on the surface of the discharge tab during the inspection and use them to illuminate the surface. Since the discharge tab is usually not coated with active material, it is usually very light-reflecting, which may require other lighting. Therefore, it is also conceivable that the line cameras 160 and the further camera 111 have spatially separated fields of view (FoV).

An inspection of the tab upstream of the separation point would possibly have the advantage that a lower transport speed can prevail there

The inspection of the discharge tab can be carried out in particular at a speed of the starting substrate B that is lower than the speed of the individual objects O during their inspection by the image sensor system 110.

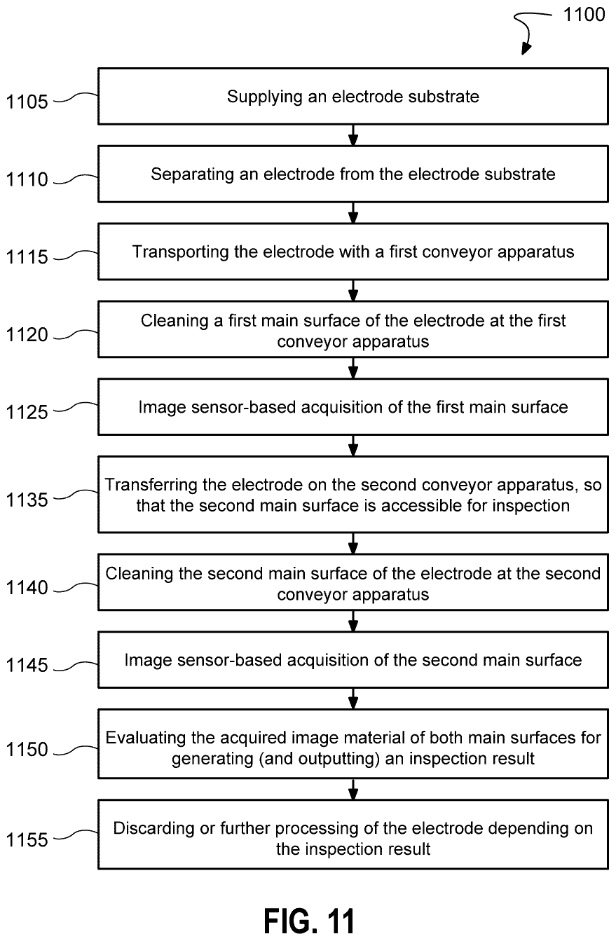

FIG. 11 uses a flow chart to show an exemplary embodiment 1100 of a method for sensor-based inspection of a physical object, wherein the method can be carried out in particular with a device according to the solution, for example according to the embodiments of such a device described herein. In the following, reference is made specifically to the embodiment 100 of FIG. 1 by way of example.

The method comprises a process 1105 for feeding a starting substrate B, in particular an electrode substrate, to a separating device 130 of the device. In a further process 1110, a single electrode E (or precursor thereof) is separated from the starting substrate B using the separating device 130, in particular by cutting or punching.

Then, in a further process 1115, the separated electrode E is picked up by a first conveyor apparatus, in particular a first vacuum conveyor belt 105a, and then continuously transported during the further course of the method 1100. During transport, the electrode is guided by the first conveyor apparatus past a cleaning apparatus 125a, where a first main surface of the electrode E is cleaned, in particular by suction and/or blowing air (optionally ionized blowing air), before it is subject to image sensor-based acquisition by a first image acquisition unit 110a in a further process 1125.

The electrode E is then transferred to a second conveyor apparatus, in particular a second vacuum conveyor belt 105b, in such a way that the second main surface of the electrode E opposite the first main surface becomes accessible for inspection. As already explained above with reference to FIG. 1, this can be done in particular by the electrode E then being transported further while hanging on the second vacuum conveyor belt 105b.

This is followed again by a cleaning process 1140, this time for the second main surface, and a subsequent image sensor acquisition 1145 of the second main surface by a second image acquisition unit 110b. The digital image material, in particular video material, acquired by the two image acquisition units 110a and 110b is fed to an image evaluation unit 150 of the device, in which the image material is evaluated. This evaluation can be carried out in particular by comparing the image material with a reference image material, which can in particular correspond to an undisturbed surface of the electrodes, so that any deviations between the surface shown in the image material and a corresponding surface from the reference image material can be acquired and evaluated, in particular classified, by, in particular, automated image comparison methods. The use of evaluation methods based on machine learning is also conceivable for this purpose. The evaluation provides an inspection result which at least indicates whether a fault was acquired or not. In the context of a more complex classification, it is also conceivable that the inspection result additionally or instead indicates a frequency and/or type of the acquired fault(s).

The inspection result can finally be used to either further process the inspected electrode in a further process 1155 depending on the inspection result, for example to assemble it into a galvanic cell by at least one separator and another electrode with the opposite pole, or to reject it as defective in order to save further time and material for further processing that is then no longer effective.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

What is claimed is:

1. A device for sensor-based inspection of a physical object, wherein the device comprises:
a transportation device for transporting, along a transportation path, a physical object to be inspected;
an image sensor system with at least one image sensor for image sensor-based acquisition of the object at least in portions, while the object is continuously moved relative to the image sensor system along the transportation path by the transportation device;
an illumination device for illuminating, in a wavelength range that can be detected by the image sensor system, a respective surface of the object to be inspected, so that the image sensor system can perform image sensor-based acquisition of the surface, at least in portions, in a surface area illuminated in this way; and
a shielding device for shielding the image sensor system from radiation not originating from the illumination device;
wherein the image sensor system has a number N, with N≥1, of digital line cameras each with a plurality of camera pixels arranged in a line, wherein the lines of the line cameras each run transversely to the transportation path.

2. The device according to claim 1, wherein the transportation device is configured to move the object relative to the image sensor system in such a way that at least two opposite sides of the object can be subject to image sensor-based acquisition by the image sensor system.

3. The device according to claim 2, wherein the transportation device comprises:
a first conveyor device which is configured to transport the object lying down, while a first side of the object is at least partially acquired by the image sensor system; and
a second conveyor device which is configured to transport the object in a suspended position, while a second side opposite the first side of the object is at least partially acquired by the image sensor system.

4. The device according to claim 2, wherein the transportation device comprises a turning device for turning the object, which turning device is configured to turn the object between an at least partial image sensor-based acquisition of a first side of the object and an at least partial image sensor-based acquisition of a second side of the object opposite the first side.

5. The device according to claim 2, wherein the transportation device comprises two conveyor devices separated from one another by a gap, each of which is configured to transport the object lying or suspended, and the image sensor system is configured to perform image sensor-based acquisition of the two opposite sides of the object, while a portion of the object (O) to be subject to image sensor-based acquisition on both sides passes through the gap during operation of the transportation device.

6. The device according to claim 1, further comprising a separating device arranged upstream of the image sensor system in relation to the transportation path, for separating the object from an initial object, wherein:
the transportation device comprises a transportation table which is arranged upstream of the separating device with respect to the transportation path and which transportation table has at least two asynchronously operating fixing devices, each movable along the direction of the transportation path, for temporarily fixing the object on the transportation table;
wherein the device is configured to control the movements of the fixing devices in a coordinated manner so that they cooperate to supply the starting object stepwise to the separating device to enable separation of the object from the starting object for each step while the starting object is at rest relative to the transportation device.

7. (canceled)

8. The device according to claim 1, further comprising a cleaning device for cleaning the object, which cleaning device is arranged upstream of at least one of the line cameras of the image sensor system with respect to the transportation path.

9. The device according to claim 1, wherein the image sensor system is configured such that at least one of the line cameras has an optical axis, the direction of which defines a fixed or variably adjustable acute angle φ with φ<90° with respect to a support surface provided on the transportation device for receiving the object during the image sensor-based acquisition.

10. The device according to claim 1, wherein the image sensor system has at least one mirror and is configured such that at least one of the line cameras has an optical axis which is directed towards the mirror, so that the line camera can perform image sensor-based acquisition of a mirror image of at least a portion of the object (O) generated by the mirror.

11. The device according to claim 1, wherein the image sensor system comprises, in addition to the N line cameras, at least one further camera, the field of view of which extends, along a direction running transversely to the transportation direction (x), beyond the cumulative field of view of the N line cameras.

12. The device according to claim 1, wherein the image resolution of at least one of the line cameras is at least 6.8 μm per pixel.

13. The device according to claim 1, wherein the image sensor system comprises, in an optical path, an optics with a magnification factor in the range of from −0.675× to −0.875×, and wherein the optics for determining the magnification factor has at least one spacer ring.

14. (canceled)

15. The device according to claim 1, claims, wherein the shielding device comprises one or more darkrooms in which the N line cameras together are housed in order to protect them from radiation not originating from the illumination device.

16. The device according to claim 1, wherein the device is configured to control, or control with feedback, an acquisition frame rate of the image sensor system depending on the transportation speed of the object during a continuous transportation by the transportation device.

17. The device according to claim 1, wherein the illumination device comprises one or more light-emitting diodes as radiation sources for illuminating the respective surface of the object to be inspected.

18. The device according to claim 1, wherein the illumination device has a main radiation direction and is configured to illuminate the surface of the object to be inspected such that the main radiation direction runs at a fixed or time variable acute angle α with α<90° with respect to a support surface present on the transportation device for receiving the object during the image sensor-based acquisition.

19. The device according to claim 1, wherein the illumination device is configured to cause a diffuse illumination of the respective surface of the object to be inspected.

20. The device according to claim 1, wherein the transportation device is constructed so as to be configurable such that a position of the transportation device can be adjusted along a direction running transversely to the transportation path.

21. The device according to claim 1, further comprising an image evaluation device for evaluating image material acquired by the image sensor system to detect, by image processing, any deviations of the object represented in the image material from a reference state of the object.

22. A method of inspecting a physical object in a sensor-based manner, wherein the method is carried out using a device according to claim 1.

23. (canceled)
